(19) United States
(12) Patent Application Publication
(10) Pub. No.: US 2009/0189991 A1
(43) Pub. Date: Jul. 30, 2009

(54) METHOD AND APPARATUS EMPLOYED IN CAMERA FOR INDIVIDUATION ADJUSTMENT

(75) Inventor: Kan-Ju Lee, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/109,691

(22) Filed: Apr. 25, 2008

(30) Foreign Application Priority Data
Jan. 29, 2008 (CN) 200810300247.X

(51) Int. Cl. H04N 5/228

(52) U.S. Cl. 348/222.1

(57) ABSTRACT

An individuation adjustment device of a camera includes an initialization module, an image capturing module, a common-difference setting module, a reproducing module, a selection module, and a storage module. The initialization module is configured for initializing a primary parameter value of the camera. The common-difference setting module is configured for determining a common-difference value. The reproducing module is configured for reproducing a plurality of images having different parameter values relative to each other. The parameter values are calculated according to the primary parameter value and the common-difference value. The selection module is configured for selecting one of the images according to the agreement of the user. The storage module is configured for storing the image selected by the selection module. User can select an image having all kinds of individual parameter according to the requirement of the user utilizing the individuation adjustment apparatus.

### RELATED FIELD

The present invention relates to an individuation adjustment apparatus, and in particular, to a method and apparatus employed in a digital camera for individuation adjustment.

### BACKGROUND

With the development of technology, most conventional digital cameras can generate images of several different styles by altering the parameters of the cameras. Many of these parameters having been pre-configured in the cameras, however, can not be changed base on user-specific requirements. Furthermore, the pre-configured styles in the cameras limit the extent of individuation that is achievable.

It is desired to provide an individuation adjustment apparatus employed in a camera, which can overcome the above-described deficiency.

### SUMMARY

In accordance with the present invention, an individuation adjustment device of a camera includes an initialization module, an image capturing module, a common-difference setting module, a reproducing module, a selection module, and a storage module. The initialization module is configured for initializing a primary parameter value of the camera. The image capturing module is configured for capturing an image and acquiring a parameter value of the image. The common-difference setting module is configured for determining a common-difference value. The reproducing module is configured for reproducing a plurality of images having different parameter values relative to each other. The parameter values are calculated according to the primary parameter value and the common-difference value. The selection module is configured for selecting one of the images. The storage module is configured for storing the image selected by the selection module and the parameter value of the selected image.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of preferred and exemplary embodiments thereof and with reference to the accompanying drawings, in which:

FIG. 1 is a block diagram of an individuation adjustment apparatus in accordance with an exemplary embodiment;

FIG. 2 is a block diagram of a circuitry of a digital camera;

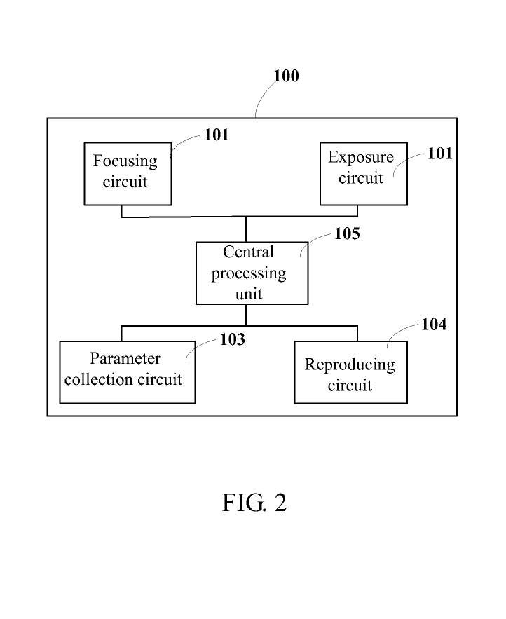

FIG. 3 is a flow chart of an exemplary individuation adjusting method for adjusting the parameter of a captured image, utilizing the system of FIG. 1; and

FIG. 4 is a flow chart of steps for initializing a primary parameter value, according to the method of FIG. 3.

### DETAILED DESCRIPTION OF EXEMPLARY EMBODIMENTS

A detailed explanation of an individuation adjustment device for adjusting a parameter of an image according to an exemplary embodiment will now be made with reference to the drawings attached hereto.

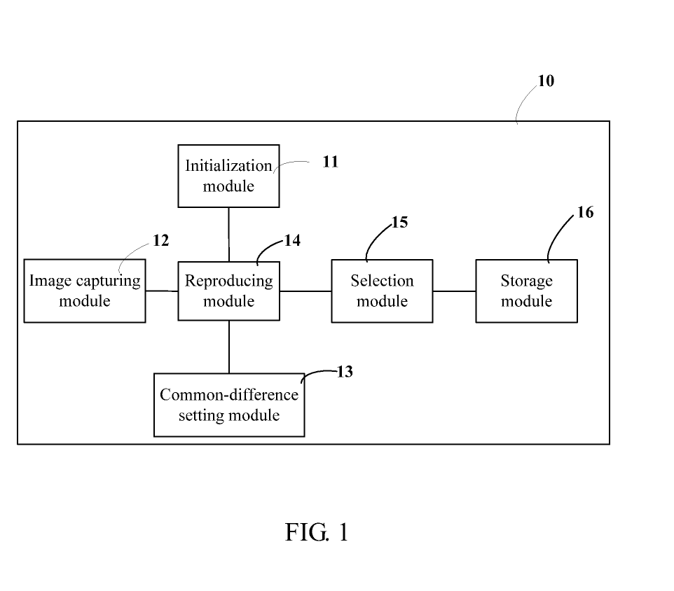

Referring to FIG. 1, an individuation adjustment device of a digital camera according to the exemplary embodiment is shown. The individuation adjustment device 10 includes an initialization module 11, an image capturing module 12, a common-difference setup module 13, a reproducing module 14, a selection module 15, and a storage module 16.

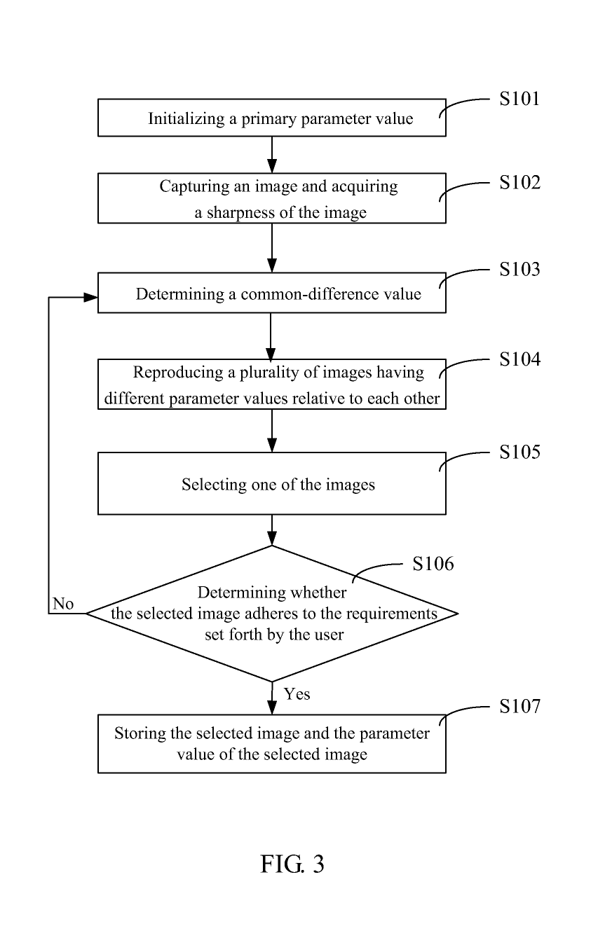

It should be noted that the digital camera, as shown in FIG. 3, also includes a focusing circuit 101, an exposure circuit 102, a parameter collection circuit 103, and a reproducing circuit 104 which are typical features of conventional digital cameras. Furthermore, the digital camera 100 includes a central processing unit (CPU) 105. The CPU 105 is electronically connected to the focusing circuit 101, the exposure circuit 102, the parameter collection circuit 103, and the reproducing circuit 104 and performs the general management of various operations of the digital camera 100 including a photometering operation, an automatic focusing (AF) operation, an automatic exposure operation, a film winding and rewinding operation, etc. In the exemplary embodiment, the CPU 105 carries out predetermined operations in response to communications with the initialization module 11, the reproducing module 14, and the storage module 16.

The initializing module 111 is configured for initializing primary parameter values of the digital camera 100. The parameter values of the digital camera 100 include white balance gain, contrast, sharpness, smooth, or the like. In the present embodiment, the parameter value of the digital camera's sharpness is presented as an example of the primary parameter value to explain configurations and working principles of the individuation adjustment device.

The image capturing module 12 may be a camera module having an image capturing device, such as CCD image sensor, CMOS image sensor, or the like, and is configured for capturing an image and acquiring a parameter of the image.

The common-difference setup module 13 is configured for determining a common-difference value to adjust the sharpness of the captured image. The common-difference value can be directly input or selected by a user from a number of values stored in the storage module 16 beforehand. In the exemplary embodiment, the common-difference value is selected manually from multiple values.

The reproducing module 14 is configured for reproducing a plurality of images having different parameter values relative to each other. The reproducing module 14 reproduces multiple images in cooperation with the reproducing circuit 104 and the CPU 105 disposed in the digital camera 100, as this is a typical feature of the digital cameras. These parameter values are calculated according to the primary parameter value and the selected common-difference value. The parameter value of the multiple images is a series of values and form an arithmetic sequence. One of the values in the arithmetic sequence is the primary parameter value and an absolute difference between each two successive values in the arithmetic is the common-difference value. For example, if the primary parameter value is 0 and the common-difference is 5, and so forth, the arithmetic sequence may be −10, −5, 0, 5, 10. Therefore, the general term of the arithmetic sequence is n±n×5, wherein n is an integral and not limited in the embodiment. In the present embodiment, n is 5 only as a present example to explain the selection of the parameters of the images.

The selection module 15 is configured for selecting one of the images. When a user of the digital camera 100 finds a desired image of the multiple images reproduced by the reproducing module 14, the user may press a shutter button (not shown) disposed in the outer surface of the digital camera 100 to control the selection module 15 to select the desired image in cooperation with the CPU 105.

The storage module 16 is configured for storing the image selected by the selection module 15 and the parameter values of the selected images. The storage module 16 may be a RAM, a hard disk drive, or the like. When the selection of the desired image is completed, the CPU 105 may store the image into the storage module 16 for further processing, for example printing.

Referring to FIG. 3, a flow chart of an exemplary individuation adjusting method for adjusting the parameter of the captured image is shown. In the present embodiment, sharpness of the image is exemplified as the adjusted property of the image with the primary sharpness value 0 and the common-difference value 5 explained in the method. The method includes:

step S101: initializing a primary parameter value of the digital camera 100;

step S102: capturing an image and acquiring a sharpness value of the image;

step S103: determining a common-difference value;

step S104: reproducing a plurality of images having different parameter relative to each other;

step S105: selecting one of the images; In the present embodiment, the sharpness of the selected image is 10.

step S106: determining whether the selected image adheres to the requirements set forth by the user; and

step S107: if the selected image is acceptable by the user, store the selected image along with the parameter values associated with the selected image.

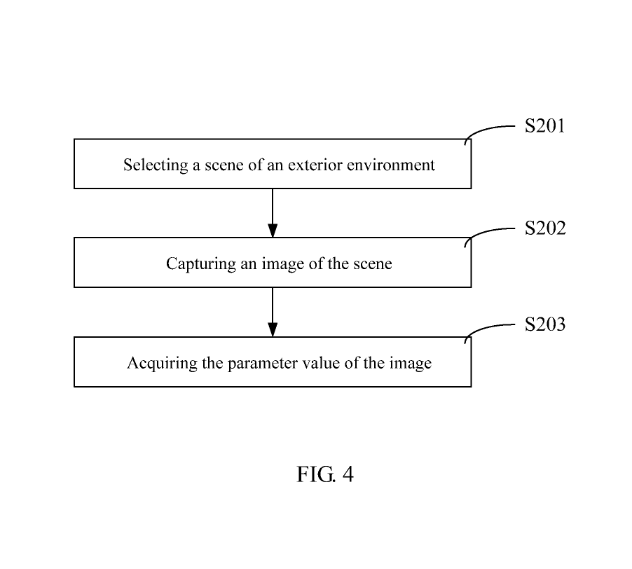

In step S101, the primary parameter value of the camera is manually initialized by the user according to the user-specific preferences and particularly, the primary parameter value can be initialized according to an exterior environment by capturing an image. Referring to FIG. 4, a flow chart of steps for initializing the primary parameter value includes:

step S201: selecting a scene of the exterior environment;

step S202: capturing an image of the scene; and

step S203: acquiring the parameter value of the image via the parameter collection circuit 103.

As described above, the parameter value of the image is obtained as the primary parameter value that is stored in the storage module 16. In the exemplary embodiment, the primary parameter value of sharpness is 0.

In step S103, the common-difference value is input or selected manually. In the present embodiment, the common-difference value is 5 to begin with.

In step S106, if the user is not satisfied with the selected image, the sharpness value of the selected image is regarded as the primary parameter value of the digital camera 100 and step S103 is executed again. That is to say, 10 is regarded as the primary sharpness value during the next adjustment. And the common-difference value needs to be input or selected again. The common-difference value may be refined to 2 for an example. Then, steps S104 through S106 are carried out again until the user selects a desired image and said image is stored in the storage module 16.

As described above, the user can select an image of various parameters according to the requirements of the user utilizing the individuation adjustment apparatus. Moreover, these individual parameters of the image captured by the digital camera may be stored in the storage module for future use by the users.

It should be understood that the above-described embodiment is intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. An individuation adjustment device of a camera, comprising:
an initialization module configured for initializing a primary parameter value of the camera;
an image capturing module configured for capturing an image and acquiring a parameter value of the image;
a common-difference setting module configured for determining a common-difference value;
a reproducing module configured for reproducing a plurality of images having different parameter values relative to each other, the parameter values being calculated according to the primary parameter value and the common-difference value;
a selection module configured for selecting one of the images; and
a storage module configured for storing the image selected by the selection module and the parameter value of the selected image.

2. The individuation adjustment device as claimed in claim 1, wherein the parameter of the camera is initialized automatically.

3. The individuation adjustment device as claimed in claim 1, wherein the primary parameter of the camera is manually input.

4. The individuation adjustment device as claimed in claim 1, wherein the different parameters of the images relative to each other are a series of values as an arithmetic sequence and one of the values in the series of values is the primary parameter value.

5. The individuation adjustment device as claimed in claim 4, wherein the series of values ranges from a set of negative values through to a set of positive values.

6. The individuation adjustment device as claimed in claim 4, wherein an absolute difference between each two successive values in the series of values is the common-difference value.

7. A method for adjusting a parameter value of an image captured by a camera, comprising:
initializing a primary parameter value by the camera automatically;
acquiring a parameter value of the image;
determining a common-difference value;
reproducing a plurality of images having different parameter value relative to each other, wherein the parameter value of each image is calculated according to the primary parameter value and the common-difference value;
selecting one of the images according to the agreement of an user; and
storing the selected image.

8. The method as claimed in claim 7, wherein initializing the primary parameter value automatically comprising:
selecting a scene of an exterior environment;
capturing an image of the scene; and
acquiring the parameter value of the image.
